(19) United States
(12) Patent Application Publication
(10) Pub. No.: US 2006/0116894 A1
(43) Pub. Date: Jun. 1, 2006

(54) Talent management and career management system

(76) Inventor: Anthony M. DiMarco, Poughkeepsie, NY (US)

Correspondence Address: HESLIN ROTHENBERG FARLEY & MESITI PC, 5 COLUMBIA CIRCLE, ALBANY, NY, 12203, US

(21) Appl. No.: 10/998,848

(22) Filed: Nov. 29, 2004

(51) Int. Cl. G06Q 99/00

(52) U.S. Cl. 705/1

(57) ABSTRACT

A multi-purpose talent management and career management system for connecting buyers and sellers of talent, directly or via intermediaries such as recruiters, through the use of visual and persistent talent pools. Individual hiring managers and recruiters can create and manage their own talent pools of highly attractive active and passive job seekers that they wish to consider for current or future job opportunities. These talent pools are created simply by adding an individual's visual career history to the talent pool. The hiring manager or recruiter can easily create job opportunity profiles and send them simultaneously to one or many people in their talent pool. Individuals receive these job opportunities and can quickly review them and respond to them while maintaining complete control over their anonymity and accessibility.

### CROSS REFERENCE TO RELATED APPLICATION

This non-provisional application is related to patent application Ser. No. 10/379,188 filed on Mar. 6, 2003 and published by the Patent Office on Sep. 18, 2003, Publication No. US-2003-0177027-A1.

### BACKGROUND OF THE INVENTION

1. Field of the Invention

Talent markets are comprised of buyers and sellers of talent as well as intermediaries or brokers of talent who bring the buyers and sellers together. Buyers of talent are most often hiring managers while sellers of talent are individuals who desire to put their full portfolio of capabilities to work for another. Brokers can be people (e.g., recruiters, headhunters, etc.), organizations (e.g., placement firms), job boards (e.g., Monster.com, CareerBuilder, etc.), or software applications (e.g., job/resume posting systems). Brokering is essentially a match making process, which attempts to optimize the match between the job requirements of the buyer with the portfolio of capabilities of the seller. In order to determine if there is a potential match, the primary communication vehicle of the buyer is the “job specification” and the primary communication of the seller is their resume.

Entire industries have formed around the brokering of talent. In the US alone, there are over 10,000 companies who identify themselves as recruiting firms. Some of these companies are very large and can have several thousand employees acting in the role of recruiter, while others are small boutiques that consist of only one or two people. Their role is to find individuals that meet the specific job requirements of an organization. There are also over 400 companies who classify themselves as employment agencies or placement firms. These organizations also bring buyers and sellers of talent together, but often for temporary employment situations. There are also thousands of recruiters employed within companies, with a role of fulfilling the talent needs of the organization. In addition, there are literally thousands of job boards which help make buyers and sellers of talent visible to each other by posting the jobs of buyers and the resumes of sellers, and enabling both parties to search for suitable matches.

While it is clear that entire industries have formed around brokering talent, it has also become clear that the traditional brokering mechanisms and processes are highly inefficient and often ineffective. For example, active job seekers, those who are actively seeking a new job, are often frustrated by the lack of responsiveness of buyers of talent. They often will get no response at all to a submittal of their resume for a specific job opportunity. This in turn motivates the active job seeker, especially when desperate, to find work, to apply for hundreds of jobs—even those they are clearly not qualified for, in order to increase the odds that someone will respond to them. As a result, companies are inundated with resumes of people who are not qualified for the job. These unqualified candidates obscure the relatively few qualified candidates who have also responded, forcing the employer to find ways to wade through or filter out the few that might be good matches. Because of the shear volume of resumes, employers find it difficult to respond to those who are not qualified, leaving most applicants completely in dark, thus completing the vicious cycle.

In addition to active job seekers, there are “passive job seekers”, or those who are not actively seeking a new job. They are most often fully employed, and while they are not actively looking for a new job, they will often consider a new job if it is attractive enough relative to their current job. Passive job seekers represent 91% of the Human Capital Market. (See IBN: interbiznet.com, “2001 Electronic Recruiting Index, The Human Capital Marketplace, Executive Summary”). This surfaces another significant inefficiency in the talent brokering market since the thousands of job boards only deal with active job seekers, since those are the only resumes being submitted. So companies are limiting themselves to only 9% of the population when they use job boards—not an efficient way to fulfill their talent needs. The only way for companies to get at this enormous, passive job seeker talent pool, is through recruiters who use inefficient and manual networking techniques to find people who are hidden within companies and invisible to the buyers of talent. The bottom line is the talent brokering “system” is broken or at best, highly inefficient. Then again, that's why “brokers” are needed in the first place, to compensate for a highly inefficient system for bringing buyers and sellers together. What is needed is a new mechanism for brokering talent.

The present invention, in the area of talent management and career management, includes a new mechanism for brokering talent that addresses many of the inefficiencies described above. On the seller side, it brings the enormous passive job seeker population into the job market by enabling passive job seekers to have “controlled visibility” in the job market. Passive job seekers are too busy to be bothered with recruiters or headhunters and they realize that even if they engaged a headhunter, they would most likely be placed in a small set of companies that the headhunter deals with. In addition, they often may not have an up to date resume, and, they certainly do not want their resume floating around on job boards. What they need is a mechanism for being visible to a large number of diverse recruiters as well as to hiring managers, without the need for a resume, and with complete control over their anonymity and their accessibility. They need to have control over how and when they respond to the recruiter, including how and when they disclose their identity and how and when they provide additional information. It is a system that more accurately reflects the power of the knowledge worker, a power that will return to the knowledge worker as the supply and demand dynamics shift back to a “sellers market”.

On the buyer or broker side, they need a way to have persistent visibility to this enormous, passive job seeker population. The job boards contain resumes of only active job seekers, so once they find work, their resumes disappear from the job boards and they join the ranks of the invisible passive job seeker population, never to be seen again, until they begin to actively seek their next job. At an individual recruiter level, they need to be able to create a talent pool of potential high value candidates that could be good fits for current or future job opportunities. They need to be able to efficiently manage this talent pool and quickly select the subset of candidates that they wish to received notification of a specific job opportunity. They need to be able to easily track responses from individuals, including the ability to quickly review their career history in a visual format.

2. Description of the Prior Art

The inefficiencies of the talent markets have created a comprehensive set of needs that are not being effectively met by existing approaches to brokering talent, in fact, it can be argued that the current approaches are also a cause of the inefficiency. State of the art for resume boards is often “cutting and pasting” your Microsoft Word version of your resume into a web-based system. In order to be found by the buyers of talent searching the resume database, you either have to enter key words on your own or the resume board scans your resume file automatically for the key words. A common approach is disclosed in U.S. Pat. No. 5,197,004 by Sobotka et al., entitled “Method and Apparatus for Automatic Categorization of Applicants from Resumes.” In this approach, resume based solutions deal with traditional resumes in traditional ways such as inputting a computer readable version of the text and doing text mining to interpret and assess the relevancy of a resume for a particular job. They are limited by the unstructured and inconsistent approaches used by resume authors and the system does not lend itself easily to relational data searches, but is limited to text and keyword searches.

The most advanced resume board providers use text-parsing technology to pull apart a traditional resume so it can be stored in a relational database, which is more suitable for searching. An example of this approach is disclosed in U.S. Pat. No. 5,758,324 by Hartman et al., entitled “Resume Storage and Retrieval System”. It takes a traditional resume and breaks it down into components and stores those components in a database for retrieval. This is an improvement over the method in U.S. Pat. No. 5,197,004 but it is still limited to the unstructured and inconsistent resume source material that impacts the effectiveness of any relational searches. It helps employers more effectively sort, store and retrieve resume content but does not provide a resume system that is relational from the point of creation.

These same limitations impact the effectiveness of external resume boards (e.g., Monster.com, Hotlobs.com) and the systems and methods they are based on since they are tied to the same traditional resume source materials. An example of such a system and approach is disclosed in U.S. Pat. No. 5,978,768 by McGovern et al., entitled “Computerized Job Search System and Method for Posting and Searching Job Openings via a Computer Network.” This is an employment recruiting method and approach based on matching information pertaining to a job opening with information provided by a user on the types of jobs preferred and a method for informing the user when there is a potential match. Unlike most traditional external resume boards, this approach does not store all of the resume and job openings but when there is a perceived match, it passes resumes directly through to the company and passes the job description through to the individual. This is an improvement since it provides additional privacy to both the company and the individual. It does not provide for anonymous higher level visual representations of an individual's career experiences that can help an employer quickly search and assess a broad base of potential candidates. And because of the lack of anonymity of the resume owner, it will cause the recruiters to primarily see only active job seekers. The often more valuable and highly desirable passive job seekers will not be visible since they would not have posted their resumes and job interests on any of these resume and job boards. In addition, these approaches are usually limited to external candidates and cannot be used effectively for making internal candidates and their career experiences and visual resume information easily accessible within a company.

The prior art for recruiters is even more limited. Systems designed to support recruiters are often limited to contact management systems, in other words, an automated “rolodex”. Some of the more advanced systems for recruiters have incorporated many of the resume board capabilities mentioned above so that information about a candidate can be gleaned from their resume and some searching and filter done to provide a set of potential candidates for an opportunity. Examples of this include DeskFlow from Workflow International Inc. and recruiter from iCIMS. One example of prior art that begins to move beyond traditional resume data and provides a mechanism for recruiters and candidates to engage on a one-to-one basis is Relationship Performance Recruiting from TalentSphere, LLC. They do this by providing additional preference fields for candidates, opportunity profiles that describe the job opportunity, and matching between the two.

The prior art is not capable of creating visual talent pools of both passive and active job seekers for individual recruiters. It is also not capable of motivating an opt-in process where individuals make themselves visible because they are comfortable with their high-level visual career history, and the complete control they have over their anonymity and accessibility. A revolutionary new approach to brokering talent is required to address the inefficiencies of bringing the buyers and sellers of talent together in the talent markets.

### SUMMARY OF THE INVENTION

An object of the present invention is to provide a mechanism that enables more efficient and effective brokering between buyers and sellers of talent. The present invention is comprised of three major functions:
Job Opportunity Profile Creation—for the web-based creation of a job opportunity profile that can fully describe a job opportunity to a potential candidate.
Talent Pool—for individual recruiters to be able to select and provide persistent and instant access to the Career Views (a candidate's visual snapshot of career experiences) of potential high value candidates for existing and future job opportunities. And the ability to manage the talent pool by archiving, unarchiving or deleting Career Views from the pool. And the ability to quickly and easily select a single job opportunity profile and a subset of the talent pool to receive the job opportunity.
Talent Broker—a web-based method for individuals to receive and respond to job opportunities sent to them by recruiters while maintaining their anonymity and accessibility. This includes the ability of the individual to inhibit any job opportunities from being sent to them and an ability to maintain anonymity through an initial response to the recruiter initiating the job opportunity.

### BRIEF DESCRIPTION OF THE DRAWINGS

For a more complete understanding of the present invention, reference is now made to the following descriptions taken in conjunction with the accompanying drawings, in which:

FIGS. 1A-1B is the present embodiment of the Job Opportunity Profile Creation screen that is used by an organization to capture the basic information about a specific job opening that they wish to communicate to a potential candidate for that job.

FIGS. 2A-2D represents the present embodiment of the Talent Pool function used by an individual recruiter to manage their pool of potential candidates that can be considered for current or future Job Opportunities.

FIG. 3 is the present embodiment of the Profile that is completed by an individual that enables an individual to allow or prevent Job Opportunities from being sent to them by recruiters and to convey additional information to the recruiter such as their Job Seeker Type and their Job Location Preference.

FIGS. 4A-4B is the present embodiment of the Job Opportunity Report that an individual uses to receive, review and respond to specific Job Opportunities sent to them by a recruiter.

### DETAILED DESCRIPTION OF INVENTION

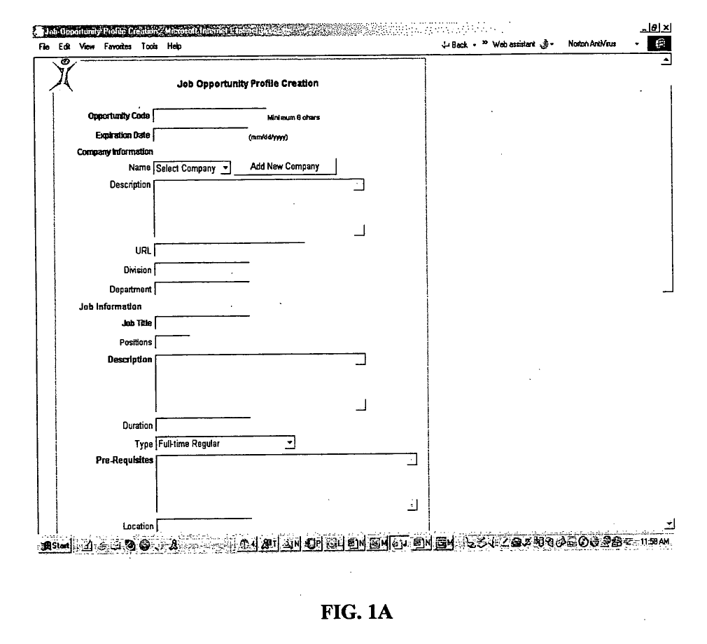

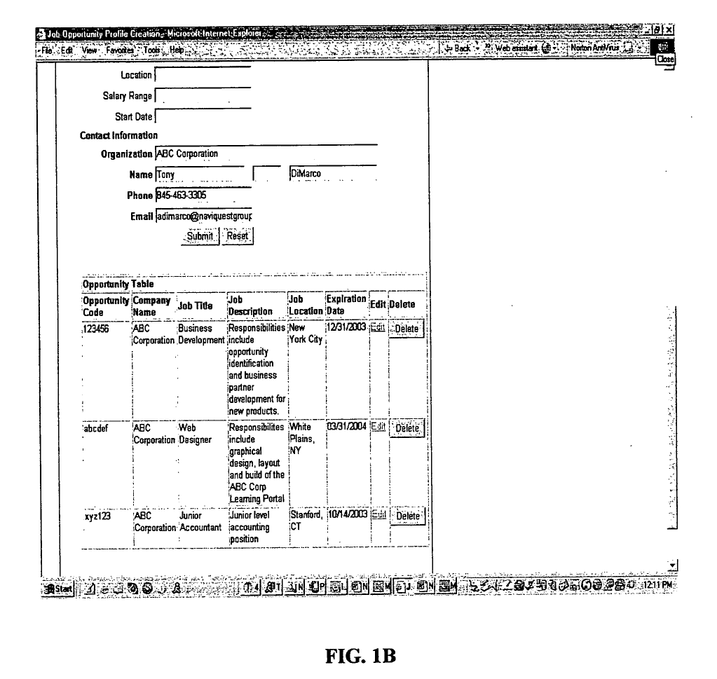

FIGS. 1A-1B is the present embodiment of the Job Opportunity Profile Creation screen that is used by an organization to capture the basic information about a specific job opening that they wish to communicate to a potential candidate for that job. The major data fields are an Opportunity Code that identifies this specific opportunity, an expiration date when the job opening is no longer valid, Company Information that describes the company at a high level and includes a link to the company website, and Job Information that fully describes the open job. Contact Information is included in case the candidate wishes to contact the recruiter directly for more information about the opportunity. In addition, at the bottom of the screen is the Opportunity Table, which contains high-level information about each Job Opportunity. This table is used to select each specific Job Opportunity Profile for editing or for deleting.

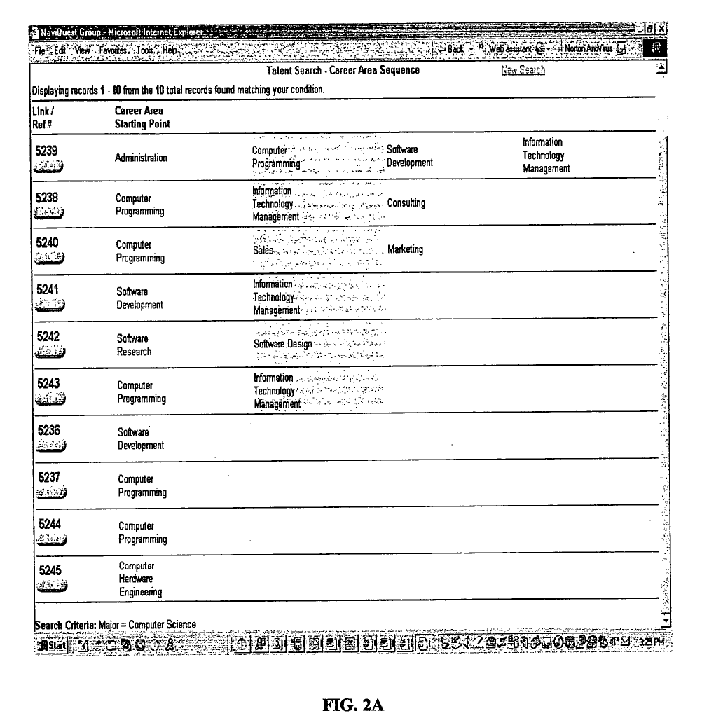

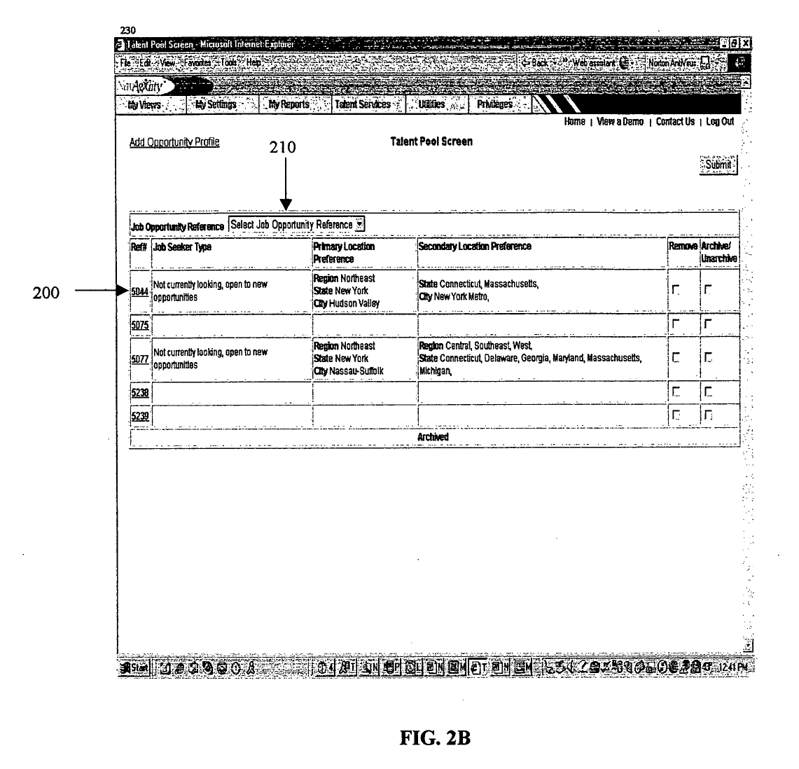

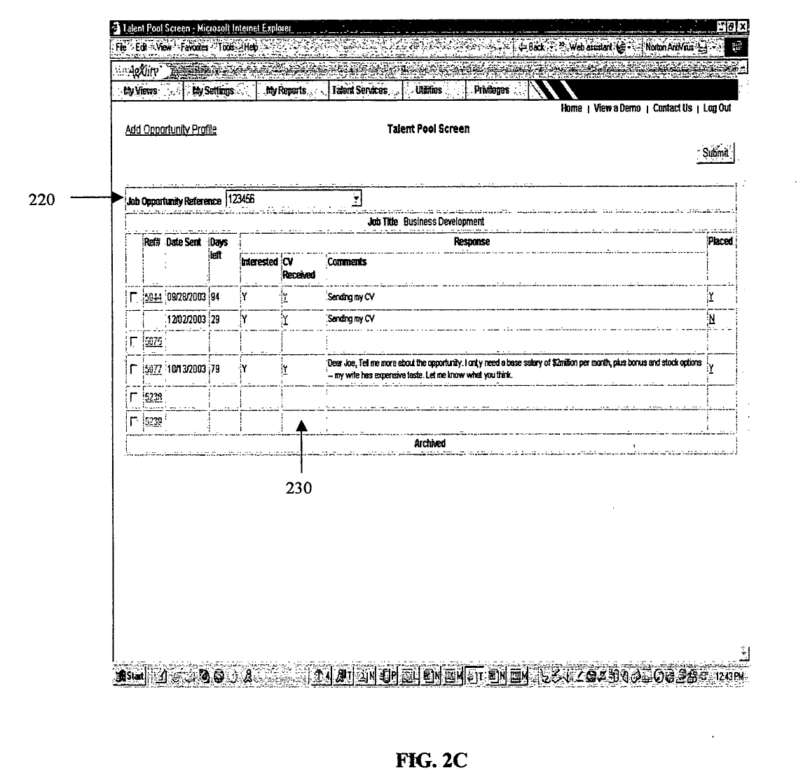

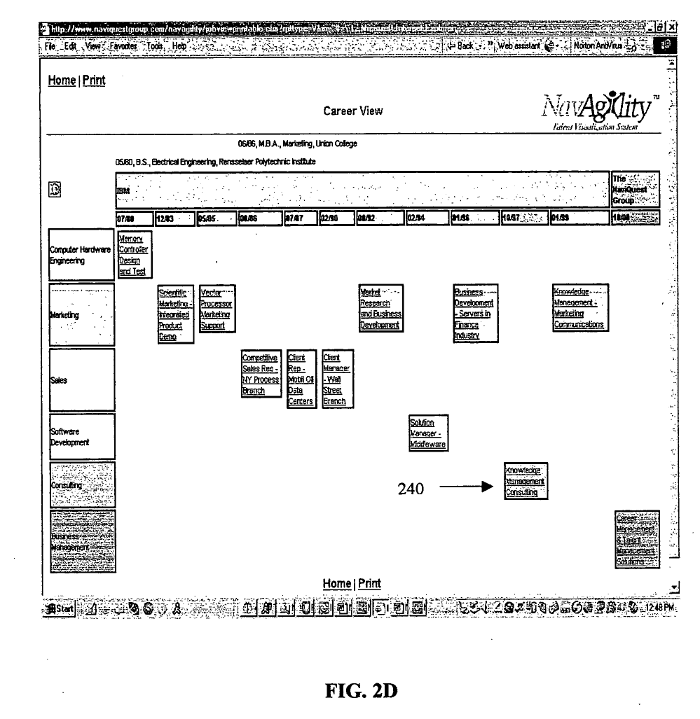

FIGS. 2A-2D represents the present embodiment of the Talent Pool function used by an individual recruiter. FIG. 2A represents the present embodiment of the Talent Pool function used by an individual recruiter to manage their pool of potential candidates that can be considered for current or future Job Opportunities.

Talent Search result screen with each row representing an individual with a Career View. After viewing the individual's Career View by selecting the Link/Ref #, the recruiter can easily add that individual to their overall talent pool by selecting the ADD button under the Link/Ref # for that person.

FIG. 2B is the present embodiment of the Talent Pool for a specific recruiter. Each row 200 in the table represents one person who has been selected by the recruiter to include in their overall talent pool (using the ADD button) and provides information about that individual to the recruiter, such as their Job Seeker Type and Location Preference. In addition, the recruiter can easily review their Career View by clicking on the Ref# link 200. A recruiter can send job opportunities regarding a specific Job Opportunity by selecting the Job Opportunity Reference Number 210 from a drop down menu.

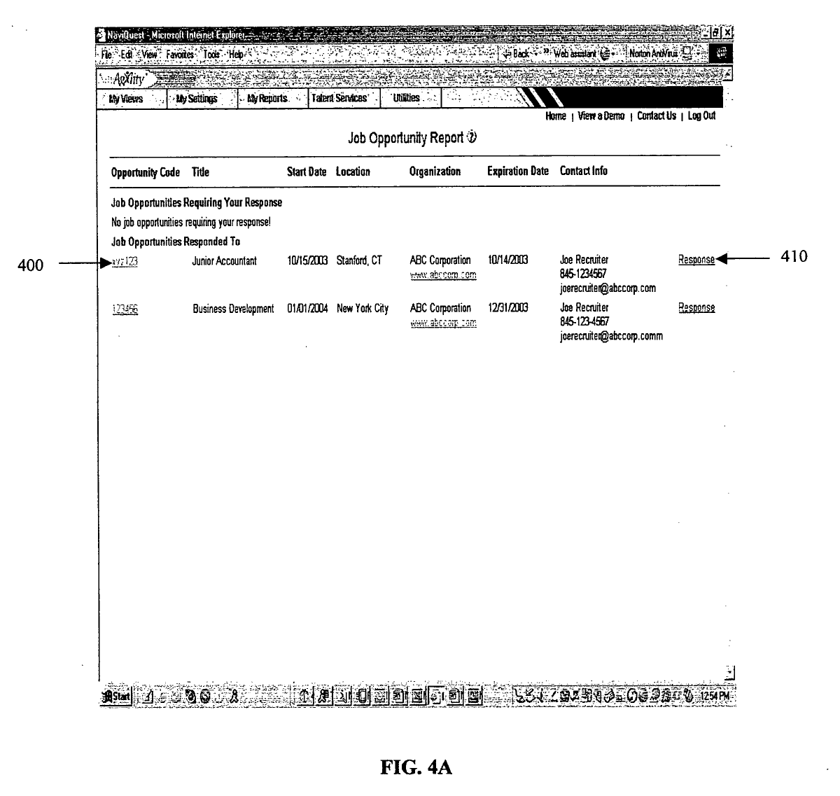

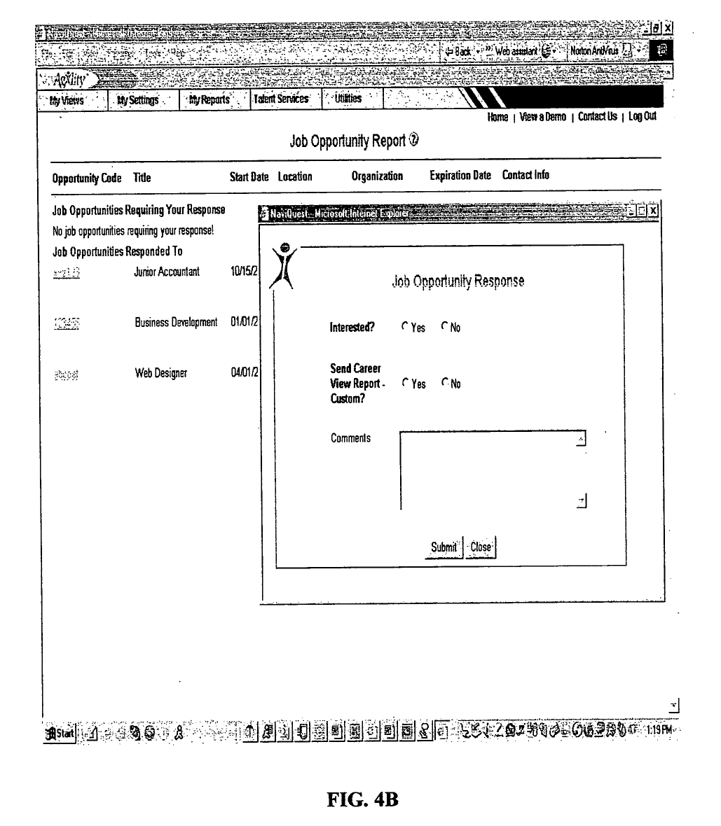

Once this done, the recruiter is presented with the screen in FIG. 2C for that specific Job Opportunity 220. In this screen, a recruiter uses the check boxes at the left of each row to select which individuals to send the specified Job Opportunity to. Then by hitting the Submit button, the Job Opportunity is sent to each individual automatically via email and it automatically shows up in the individual's Job Opportunity Report (FIG. 4A). FIG. 2C also is used to communicate the status of each Job Opportunity sent to each individual, including information such as the date sent, number of days remaining before expiration of the offer, the individual's response (e.g., Interested, Not Interested), any comments received with the response, and status indicating if they have been placed in the job or not. In addition, if a Career View Report has been received from the individual, an indication of such is provided 230 and a link is provided to the individual's Career View Report.

If the recruiter selects that link, the Career View Report is displayed (FIG. 2D) and the recruiter can then select any one of the job blocks 240 to see the detailed resume data for that specific job. For a more detailed description concerning a career view screen display, see my co-pending patent application Ser. No. 10/379,188 filed on Mar. 6, 2003, that is incorporated herein by reference.

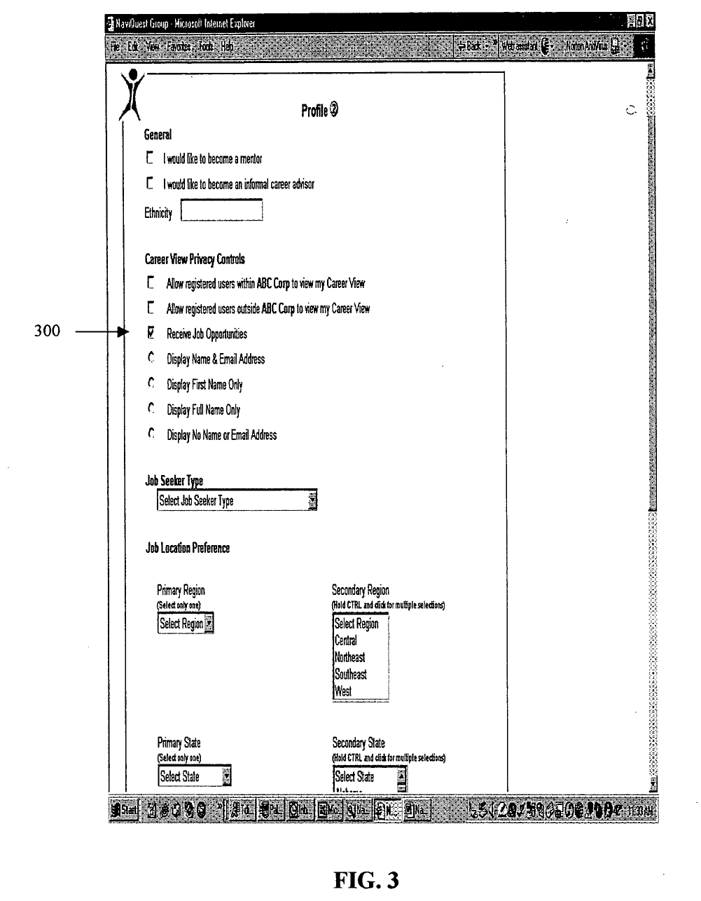

Up to this point, FIGS. 1A-1B, 2A-2D have all represented functionality provided to an individual recruiter. FIGS. 3, 4A-4B, described below, represent functionality provided to the individual candidate for a job.

FIG. 3 is the present embodiment of the Profile that is completed by an individual. A check box 300 is provided that enables an individual to allow or prevent Job Opportunities from being sent to them by recruiters. For example, a passive job seeker who in general may be interested in receiving Job Opportunities, may get very busy with a certain project and during the duration of the project, they may elect not to receive Job Opportunities since they would not be able to pursue them anyway. In addition, on this Profile Screen is the ability of the individual to convey to the recruiter their Job Seeker Type (e.g., Actively seeking a new job, Not actively seeking a new job but open to new opportunities, etc.) and the ability to identify their Job Location Preference by selecting their Primary and Secondary Region/State/City-Area.

FIG. 4A is the present embodiment of the Job Opportunity Report that an individual uses to receive, review and respond to specific Job Opportunities sent to them by a recruiter. The Opportunity Code 400 is provided for the specific Job Opportunity and it is also a link that the individual can use to see the details of the Job Opportunity. Some of the other basic information about the Job Opportunity is provided on the Report itself, such as the title, starting date, location, organization, expiration date and the recruiter contact information. A response link 410 is provided to enable the individual to respond to the Job Opportunity. The screen for responding is indicated in FIG. 4B and it includes the ability of the individual to quickly, with only two clicks, indicate interest/no interest, and to send their Career View Report-Custom (i.e., their online visual resume—depicted in FIG. 2D), and to add any comments they wish to accompany their response to the recruiter. This response is available to the recruiter in their Talent Pool (FIG. 2C).

What I claim as my invention is:

1. A talent management and career management system for brokering connections for job openings between an organization and prospective candidates, through the use of visual screens, comprising:
a server including a memory;
a talent pool formed of prospective candidates stored within the memory and containing information including the career view report of prospective candidates;
means for displaying the talent pool on a screen;
a plurality of job openings stored within the memory and containing information describing the job openings;
means for displaying the job openings on a screen;
means for viewing the career view report of prospective candidates;
means for selecting prospective candidates in the talent pool for job openings;
means for an organization to send information concerning job openings to prospective candidates selected for review;
means for a prospective candidate to view the information sent by an organization concerning a job opening; and,
means for a prospective candidate to respond to the organization concerning the job opening.

2 The system of claim 1 including means for a prospective candidate to maintain anonymity.

3. The system of claim 1 including means for a prospective candidate to block the job opening information sent by an organization.

4. The system of claim 1 wherein the job opening information includes fields that enable complete description of a specific job opening.

5. The system of claim 4 including an opportunity table for using, identifying, reviewing, selecting, editing and deleting existing job openings.

6. The system of claim 1 including a means for adding prospective candidates and their visual career reports to the talent pool.

7. The system of claim 1 including means for reviewing and managing the talent pool.

8. The system of claim 7 including means for viewing the career view report of a prospective candidate.

9. The system of claim 7 including means for removing, archiving, and un-archiving a prospective candidate from the talent pool.

10. The system of claim 1 including a means for selecting a specific job opening profile for sending to prospective candidates of the talent pool.

11. The system of claim 10 including a means for tracking the response of the selected prospective candidates to the job openings and for updating the status of the prospective candidate to the job opening.

12. The system of claim 10 including means for reviewing the career view report of a prospective candidate responding to a specific job opening.

13. The system of claim 1 including means for a prospective candidate to update prospective candidate profile information.

14. The system of claim 13 including a means for specifying primary and secondary geographic preferences and prospective candidate profile.

15. The method of brokering connections for job openings between an organization and prospective candidates, through the use of visual screens comprising the steps of:
providing a server including a memory;
forming a talent pool of prospective candidates, the talent pool containing information including the career view report of prospective candidates and storing same within the memory;
displaying the talent pool on a screen;
storing a plurality of job openings within the memory, the job openings containing information describing the job openings;
displaying the job openings on a screen;
viewing the career view reports of prospective candidates;
selecting prospective candidates in the talent pool for job openings;
sending information concerning job openings from the organization to prospective candidates selected for review;
viewing by a prospective candidate the information sent by an organization concerning a job opening;
responding by the prospective candidate to the organization concerning the job opening.

16. The method of claim 15 including maintaining the anonymity of a prospective candidate.

17. The method of claim 15 including blocking by a prospective candidate the job opening information sent by an organization.

18. The system of claim 15 including providing the job opening information with fields that enable complete description of a specific job opening.

19. The method of claim 18 including providing an opportunity table for using, identifying, reviewing, selecting, editing and deleting existing job openings.

20. The method of claim 15 including adding prospective candidates and their visual career reports to the talent pool

21. The method of claim 15 including reviewing and managing the talent pool.

22. The method of claim 21 including for viewing the career view of a prospective candidate.

23. The method of claim 21 including removing, archiving, and un-archiving a prospective candidate from the talent pool.

24. The method of claim 15 including selecting a specific job opening profile for sending to prospective candidates of the talent pool.

25. The method of claim 24 including tracking the response of the selected prospective candidates to the job openings and updating the status of the prospective candidate to the job opening.

26. The method of claim 24 including reviewing the career view report of a prospective candidate responding to a specific job opening.

27. The method of claim 15 including providing a means for a prospective candidate to update prospective candidate profile information.

28. The method of claim 27 including specifying primary and secondary geographic preferences and prospective candidate profile.
